(19) United States
(12) Patent Application Publication
(10) Pub. No.: US 2010/0192406 A1
(43) Pub. Date: Aug. 5, 2010

(54) Electrically heated insoles for footwear

(75) Inventor: Albert Au, Hong Kong (HK)

Correspondence Address: KNECHTEL, DEMEUR & SAMLAN, 525 W. MONROE STREET, SUITE 2360, CHICAGO, IL, 60661, US

(73) Assignees: P3 Limited; Reinbacher International Limited

(21) Appl. No.: 12/322,624

(22) Filed: Feb. 4, 2009

(51) Int. Cl. A43B 7/02; A43B 13/38; H05B 3/00

(52) U.S. Cl. 36/2.6; 36/43; 219/211

(57) ABSTRACT

A wire-free, rechargeable electrically heated insole for footwear. The insole comprises an upper sole and a bottom sole separated by electrical components for controlling the continuous monitoring and heating of the insole. An insert and fiber plane are also provided as a cushion for the electrical components between the upper and bottom soles. The electrical components comprise a printed circuit board electrically coupled with a thermostat, an amplifier and transistor, resistors, and a light emitting diode to form the electrical system.

An integrated battery is used to power the system. The insole is designed to be automatically activated to generate heat when the temperature of the foot inside the footwear cools to a certain temperature and automatically de-activated or discontinue generating heat when the temperature of the foot inside the footwear heats to a certain temperature.

### I. CROSS-REFERENCE TO RELATED APPLICATION

Not applicable.

### II. FIELD OF THE INVENTION

The present invention relates to electrically heating of footwear and, in particular, to a wire-free, rechargeable electrically heated insole for footwear.

### III. DESCRIPTION OF THE PRIOR ART

Electrically heated insoles for footwear are designed to provide comfort and heat to the foot of a person within their shoe or footwear during the cold weather. One such example is depicted in U.S. Pat. No. 6,657,164 entitled “Customizable Heated Insole” which discloses two heated assembly packages that combine into a kit for making a heated insole for footwear. In one example, a heating element is inserted into a sealable opening in the insole with an extended flexible power cable extending out of the sealable opening and across the length of the insole in a channel formed in the bottom of the insole for connection to a separate battery pack situated outside the footwear, and a rheostat. In certain circumstances, although electrically connected, this separation of components is cumbersome and inconvenient for the user, and the separately exposed battery pack is susceptible to possible damage apart from the insole components. Thus, there is a need and there has never been disclosed an electrically heated insole for footwear that is completely contained and operable within the insole.

### IV. SUMMARY OF THE INVENTION

The present invention is a wire-free, rechargeable electrically heated insole for footwear. The insole comprises an upper sole and a bottom sole separated by electrical components for controlling the continuous monitoring and heating of the insole. An insert and fiber plane are also provided as a cushion for the electrical components between the upper and bottom soles. The electrical components comprise a printed circuit board electrically coupled with a thermostat, an amplifier and transistor, resistors, and a light emitting diode to form the electrical system. An integrated battery is used to power the system. The insole is designed to be automatically activated to generate heat when the temperature of the foot inside the footwear cools to a certain temperature and automatically de-activated or discontinue generating heat when the temperature of the foot inside the footwear heats to a certain temperature.

### V. BRIEF DESCRIPTION OF THE DRAWINGS

The Description of the Preferred Embodiment will be better understood with reference to the following figures:

FIG. 1 is an exploded perspective view of an electrically heated insole for footwear.

FIG. 2 is an electrical schematic or circuit board diagram of the components used to operate the electrically heated insole for the footwear.

FIG. 3 is an alternate printed circuit board diagram of the electrically heated insole for footwear.

### VI. DETAILED DESCRIPTION OF THE PREFERRED EMBODIMENT

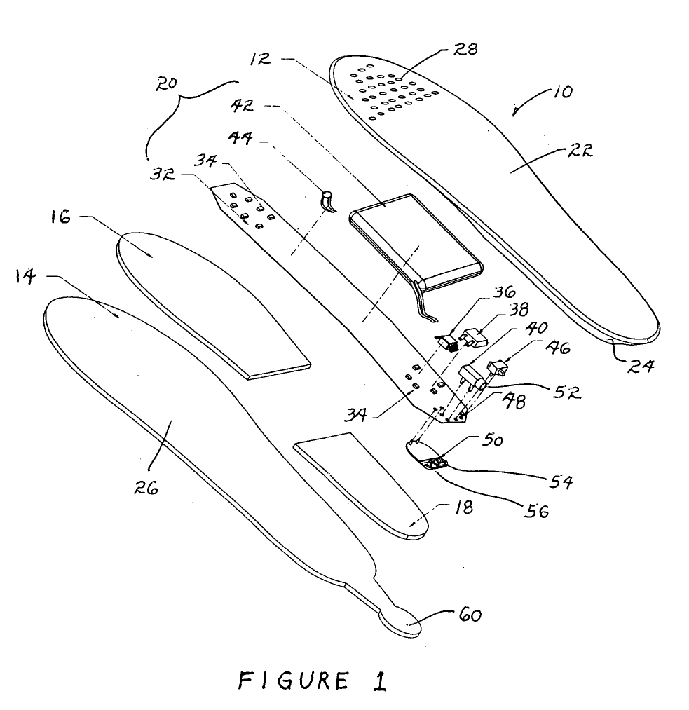

Turning first to FIG. 1, there is illustrated an electrically heated insole 10 for footwear. The electrically heated insole 10 comprises an upper sole 12, a bottom sole 14, an insert 16, a fiber plane 18, and a plurality of components 20 for electrically controlling the continuous monitoring and heating of the insole 10.

The upper sole 12 and the bottom sole 14 are ergonomically designed for forming the insole 10 for insertion into any footwear worn in cold weather. The upper sole 12 is preferably made of a heat preserving synthetic material, fabric lining 22 having a shock absorbing, ergonomically shaped polyurethane heel 24. The upper sole 12 is also provided with a plurality of holes 28 for permitting the heat from the electrical components 20 to pass through the plurality of holes 28 for more directly reaching the toes and foot of the person wearing the footwear. The bottom sole 14 is preferably made of a heat preserving synthetic material, insulating fabric lining 26 designed with heat preserving synthetic material. Alternatively, the upper sole 12 and the bottom sole 14 can be made or designed of any materials known to one skilled in the art provided that they are used in the manner described herein. A tab 30 is also provided which can be used by the person for removing or pulling the insole 10 from the footwear.

The upper sole 12 is preferably integrally bonded or molded to the bottom sole 14 along their circumference to form the assembled insole 10 with the plurality of electrical components 20 contained therebetween. Alternatively, the upper sole 12 and the bottom sole 14 may be attached to one another using any means known to one skilled in the art provided that the attachment is sufficient to form an assembled insole 10 for use as described herein.

In the preferred embodiment, the insole 10 is designed for use within footwear or shoes worn in the colder temperatures that include but are not limited to outdoor footwear, work boots, ski boots, etc. . . . Alternatively, the insole 10 may be used in any footwear or shoe where the foot or feet of the person wearing the shoe is concerned about keeping their foot or feet warm or at least at a normal body temperature. In the preferred embodiment, and as discussed in more detail below, the electrically heated insole 10 is designed to be automatically activated to generate heat when the temperature of the foot inside the footwear drops below 78.8° F. or 26° C. and automatically de-activated or discontinue generating heat when the temperature of the foot inside the footwear reaches 98.6° F. or 37° C. In this manner, the insole 10 provides a safe and warm temperature range within the footwear for maintaining the warmth of the feet of the person wearing the footwear during the colder temperature weather.

Alternatively, it is contemplated that the insole 10 could be designed to activate, or generate heat, and de-activate, or discontinue generating heat, at any temperature range. However, any such modification of the temperature range should deactivate prior to any temperatures of the foot becoming too warm which may cause the insole 10 to inflict any pain, burn, or discomfort to the foot of the person and/or should activate prior to any temperatures of the foot becoming too cold causing the insole 10 to inflict or allow pain or discomfort to the foot of the person due to the temperature within the insole 10 or the foot reaching undesired or harmful cold temperatures.

The insert 16 and the fiber plane 18 are used in combination with the plurality of electrical components 20 to create a cushion with and for assisting in securing the plurality of electrical components 20 between the upper sole 12 and the bottom sole 14.

One of the electrical components 20 comprises a circuit board 32. In the preferred embodiment, the circuit board 32 is a printed circuit board or PCB that is used to mechanically support and electrically connect the other electrical components 20 using conductive pathways, or traces, etched from copper sheets laminated onto a non-conductive substrate. Alternatively, the circuit board 32 may be any type of circuit board known to one skilled in the art that may be used to accomplish the invention described herein. Electrically coupled to the circuit board 32 are an integrated circuit 36, a plurality of resistors 34, a transistor 38, a direct current connector 40, and a battery 42. The battery 42 is preferably a rechargeable, lithium-ion battery providing 880 milliampere per hour, no memory effect, and a holding charge time of substantially 6 to 8 hours. In the preferred embodiment, the integrated circuit 36, the plurality of resistors 34, the transistor 38, the direct current connector 40, a thermostat 44, and the battery 42 are all well known electrical components and include any and all types or variations known to those skilled in the art for use in the manner described herein. Also, electrically coupled to the circuit board 32 is an on/off switch 46 and a light emitting diode 48.

Prior to use, the battery 42 of the insole 10 should be fully charged. The on/off switch 46 is protected by a soft, rubber protector cap 50. Upon removing this protector cap 50, the on/off switch 50 should be switched or toggled to the “off” position (i.e., as shown in a non-limiting example as being moved in the direction toward the direct current connector 40). An adaptor (not illustrated) is plugged into an electrical outlet (not illustrated) and then an adaptor cable (not illustrated) from the adaptor is then plugged into a charging socket 52 within the direct current connector 40 to begin charging the battery 42. It is recommended that both the left and right insole 10 for a pair of shoes be charged at the same time. This is easily facilitated by the adaptor cable from the adaptor being split into a dual end for connection and charging of both the left and right insole 10 at the same time. It is contemplated that the adaptor may be provided with a light emitting diode to display a red light during charging of the battery 42 which is changed to a green light after charging is complete. The initial charging of the battery 42 of the insole 10 may take approximately 8 hours to be fully charged. After the initial charge, regular charging of the battery 42 should only take approximately 2 hours to be fully charged again. Upon completion of the battery 42 being fully charged, unplug the adaptor and adaptor cable and the insole 10 is ready for use. Alternatively, any other means for charging the battery 42 known to one skilled in the art may be used.

To begin using the insole 10 and prior to inserting the insole 10 into the footwear, the on/off switch 46 should be switched or toggled to the “on” position (i.e., as shown in the non-limiting example as being moved in the direction toward the direct current connector 40). The soft, rubber protector cap 50 should be reattached for covering the on/off switch 46. In the preferred embodiment, the protector cap 50 has a rectangular and open box wall 54 for containing and protecting the on/off switch 46 when covered. The protector cap 50 is also provided with an adjacent plug 56 for insertion into and protection of the charging socket 52. Alternatively, it is contemplated that any means known to one skilled in the art may be used for covering and protecting both the on/off switch 46 and the charging socket 52 of the direct current connector 40. The insole 10, now after being fully charged for use, may then be inserted into the footwear.

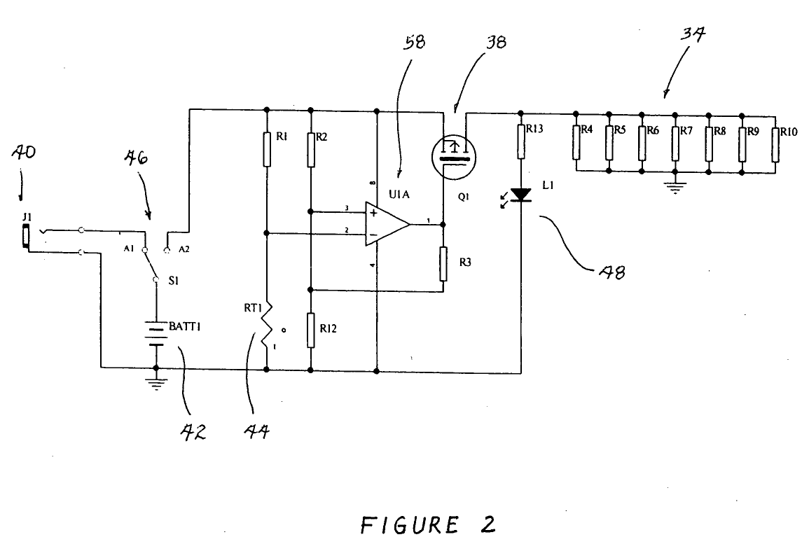

While the insole 10 is inside the footwear, the heating of the insole 10 is continuously monitored and operated by the plurality of electrical components 20. The application and use of these electrical components 20 is more clearly illustrated in the electrical schematic or circuit board diagram as shown in FIG. 2.

As discussed, when the on/off switch 46 is switched or toggled to the “off” position (i.e., S1 switch moved to A1 position), the battery 42 can be initially charged or later recharged through the direct current connector 40 from the adaptor. When the on/off switch 46 is switched or toggled to the “on” position (i.e., S1 switch moved from A1 position to A2 position), the battery 42 begins to power the circuit. If the temperature is low enough (preferably 78.8° F. or 26° C.) to cause the resistance in the thermostat 44 (i.e., RT1) to be high enough to make the potential difference at amplifier 58 (i.e., U1A,) negative terminal (2) higher than the potential difference at amplifier 58 (i.e., U1A), positive terminal (3), the amplifier 58 (i.e., U1A) output (1) will be a low level to close the transistor 38 (i.e., Q1), or in other words, power the resistors 34 (i.e., R4, R5, R6, R7, R8, R9, R10, and R13). When the resistors 34 are being powered, the insole 10 is being heated. The light emitting diode 48 will also depict a red light to indicate that the insole 10 is on or being powered by the battery 42. In the preferred embodiment, the battery life to continue heating is approximately eight hours depending upon outside temperature and quality of shoes.

While the circuit remains closed, the insole 10 is being heated. As this occurs, the temperature of the thermostat 44 (i.e., RT1) will be rising and as it does its resistance will be lowered to make the potential difference at amplifier 58 (i.e., U1A), negative terminal (2) lower. When the temperature is high enough (preferably 98.6° F. or 37° C.) to cause the resistance in the thermostat 44 (i.e., RT1) to be low enough to make the potential difference at amplifier 58 (i.e., U1A,) negative terminal (2), lower than the potential difference at amplifier 58 (i.e., U1A), positive terminal (3), the amplifier 58 (i.e., U1A) output (1) will be a high level to open the transistor 38 (i.e., Q1), or in other words, discontinue power to the resistors 34 (i.e., R4, R5, R6, R7, R8, R9, R10, and R13). In this manner, the insole 10 stops generating heat. The light emitting diode 48 (i.e., L1) will likewise no longer depict a red light to indicate that the insole 10 is no longer being heated. This on-off cycle will automatically continue for the duration that the insole 10 is being used or until the battery 42 completely discharges.

When the insole 10 is no longer needed for use, the tab 60 may be gripped by the person's fingers for easily removing the insole 10 from the footwear. Upon removal, the on/off switch 46 should be switched or toggled to the “off” position thereby opening the circuit to prevent undesired continuous monitoring and powering of the insole 10. Depending upon the length of use, the battery 42 of the insole 10 may require recharging prior to further use.

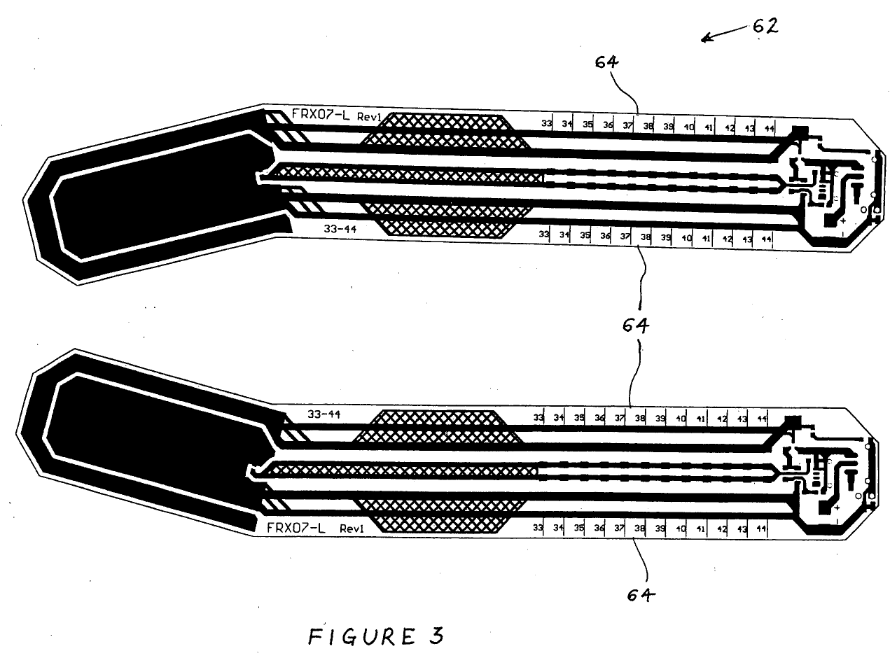

Referring to FIG. 3, there is illustrated a diagram of an alternate embodiment of the printed circuit board 62 for the insole 10. In this alternate embodiment, the printed circuit board 62 is designed such that it may accommodate the insole 10 for various sizes of footwear. This embodiment also assists in standardizing components and inventory management. In the preferred embodiment, the length of the printed circuit board 32 is pre-determined, In this alternate embodiment, the printed circuit board 62 may be altered to fit the insole 10 for commonly used sizes of footwear. Situated along the edges of the printed circuit board 62 are a plurality of markers 64. These plurality of markers 64 represent the length or size of footwear ranging from a European shoe size of 33 through a shoe size of 44. Alternatively, the plurality of markers 64 may be changed to accommodate or represent any countries' measurement or nomenclature for footwear sizes. To fit the printed circuit board 62 to an insole 10 for a desired shoe size, the printed circuit board 62 may be folded upon itself at the proper marker 64 to achieve the exact length or size required. In this alternate embodiment, if the footwear size is less than size 44, the initial fold would occur at the size 44 position. This initial fold would then be substantially aligned with the actual desired footwear size. Thus, if the actual desired footwear size was 36, the fold at the size 44 position would be engaged and aligned with the size 36 position thereby shortening the length of the printed circuit board 62 from a size 44 to a size 36. After the printed circuit board 62 is folded (as described), the area of the printed circuit board 62 that was folded (e.g., size 44 marker to size 36 marker) can be further connected with soldering to insure permanent connection of the circuitry and the system.

Thus, there has been provided a wire-free, rechargeable electrically heated insole for a shoe. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. An insole for inserting inside footwear and resting adjacent to the bottom of the footwear, comprising:
a body having an upper side and a bottom side, the body substantially conforming to the bottom of the footwear; and
means for continuously monitoring and regulating heat from the insole for heating the footwear, the means for continuously monitoring and regulating the heat self-contained within the body.

2. The insole of claim 1 wherein the means for continuously monitoring and regulating heat automatically activates heat generating means when the temperature within the footwear becomes too low and automatically stops the heat generating means when the temperature within the footwear becomes too hot.

3. The insole of claim 1 wherein the means for continuously monitoring and regulating heat from the insole comprising a circuit board having a thermostat, a transistor, and at least one resistor.

4. The insole of claim 3 wherein the means for continuously monitoring and regulating heat from the insole further comprising a battery electrically coupled to the circuit board.

5. The insole of claim 4 and further comprising a switch electrically coupled to the circuit board that regulates when the circuit board is powered by the battery.

6. The insole of claim 5 and further comprising a direct current connector electrically coupled to the circuit board for connecting an external power source to the battery.

7. The insole of claim 5 and further comprising a light emitting diode electrically coupled to the circuit board and indicating when the circuit board is powered by the battery.

8. The insole of claim 6 and further comprising a flexible cap attached to the body, the flexible cap moveable between a first position covering the switch and direct current connector exposed from within the body and a second position uncovering the switch and direct current connector for use.

9. The insole of claim 3 and further comprising a plurality of holes situated in the upper side of the body and adjacent to the at least one resistor.

10. The insole of claim 1 and further comprising a cushion insert situated adjacent to the means for continuously monitoring and regulating heat and within the body.

11. The insole of claim 1 and further comprising a finger tab extending outwardly from the bottom side of the body.

12. An insole for generating heat within footwear, comprising:
an upper sole and a bottom sole, the upper sole and the bottom sole joined together for forming the insole;
a flexible substrate having a circuit board mounted thereon;
a plurality of resistors electrically connected to the circuit board;
a thermostat electrically connected to the circuit board;
a battery electrically connected to the circuit board;
a switch electrically connected to the circuit board, the switch having a button exposed from within the insole for toggling between activating the circuit board and deactivating the circuit board;
means for securing the flexible substrate and circuit board, the plurality of resistors, the thermostat, the battery, and the switch between the upper sole and the bottom sole; and
whereby, when the circuit board is activated, the resistors automatically generating heat when the temperature within the footwear drops below a first temperature and automatically stops generating heat when the temperature within the footwear goes above a second temperature.

13. The insole of claim 12 and further comprising an integrated circuit and a transistor.

14. The insole of claim 12 and further comprising a light emitting diode electrically connected to the circuit board and providing a light exposed from within the insole.

15. The insole of claim 12 and further comprising a direct current connector electrically connected to the circuit board.

16. The insole of claim 12 and further comprising a plurality of resistors electrically mated to the circuit board.

17. The insole of claim 12 and further comprising a plurality of holes in the upper sole situated adjacent to the plurality of resistors.

18. The insole of claim 12 wherein the battery has a thickness which does not interfere with a user inserting a foot within the footwear.
